(19) United States
(12) Patent Application Publication
(10) Pub. No.: US 2022/0318695 A1
(43) Pub. Date: Oct. 6, 2022

(54) METHOD AND SYSTEM FOR INDEXING AND MAPPING SOFTWARE ASSETS OF BUSINESS

(71) Applicant: Aplas Pty Ltd, Melboume, Victoria (AU)

(72) Inventor: Mark CRAWSHAW, Melbourne (AU)

(21) Appl. No.: 17/638,071

(22) PCT Filed: Sep. 19, 2019
(86) PCT No.: PCT/IB2019/057889

§ 371 Date: Feb. 24, 2022

(51) Int. Cl. G06Q 10/06; G06Q 50/26; G06Q 10/08; G06F 8/75

(52) U.S. Cl. CPC G06Q 10/067; G06Q 50/26; G06Q 10/087; G06F 8/75

(57) ABSTRACT

A computer-implemented method, comprising: collecting information about software assets of a business, indexing the collected information to create a software index, building a software map of the software assets using the software index, styling the software map to create a styled software map, and publishing one or more of the software index, software map, and styled software map to an end-user.

### FIELD

The present invention relates to a method and system for indexing and mapping the software assets of business.

### BACKGROUND

Understanding the software architecture of business is essential to designing, delivering, managing, and improving the way software is used. Moreover, software has become integral to the operation of business and how it delivers its products and services.

However, understanding and communicating information about business software has been made more difficult than previously by the increasing scale and variety of software, the decentralisation and globalisation of people, and the increasing complexity of how systems are integrated together.

Current tools for indexing and understanding business software are designed in a manner which leads users to store information that is overly structured and detailed. As time passes this leads to stale data and a lack of quality in the software asset metadata. They are also known for being hard to derive useful knowledge as their complexity and lack of useful abstracting systems makes deriving data for decision-making difficult.

In view of this background, a need exists for improved tools for indexing and mapping the software assets of business.

### SUMMARY

According to the present invention, there is provided a computer-implemented method, comprising:

collecting information about software assets of a business;

indexing the collected information to create a software index;

building a software map of the software assets using the software index;

styling the software map to create a styled software map; and

publishing one or more of the software index, software map, and styled software map to an end-user.

The software index, software map, styled software map, and publications thereof may be loosely coupled to one another.

The software map may be partially or wholly built and maintained either manually or automatically.

The software index may comprise information about one or more of applications, application categories, integrations, integration categories, collections, collection categories, components, and component categories.

The software map may comprise a cartographic visualisation of the software index using geographic metaphors.

The geographic metaphors may comprise cities/towns, continents/states/islands and highways/roads, wherein:

applications represent cities/towns;

application categories represent continents/states/islands; and

integrations represent highways/roads.

The software map may comprise a number of attachments to a hexagonal-grid, wherein:

applications are attached as individual hexagonal grid cells;

application categories are attached as groups of hexagonal grid cells; and

integrations are attached as paths along the hexagonal grid, between hexagonal grid cells.

The styled software map may comprise style layers that comprise style layer attributes, for example, shape, colour, border, width, fill colour, and fill opacity.

The styling of the software map may further comprise zoom-based styling or data-based styling.

The present invention also provides a system comprising one or more computers and one or more storage devices storing instructions that are operable, when executed by the one or more computers, to cause the one or more computers to perform operations comprising:

collecting information about software assets of a business;

indexing the collected information to create a software index;

building a software map of the software assets using the software index;

styling the software map to create a styled software map; and

publishing one or more of the software index, software map, and styled software map to an end-user.

The present invention further provides a visualisation of software assets of a business, the visualisation comprising a software map produced by the method or system described above.

### BRIEF DESCRIPTION OF DRAWINGS

Embodiments of the invention will now be described by way of example only with reference to the accompanying drawings, in which:

FIG. 1 is a flow chart of a computer-implemented method of indexing and visualising software assets of a business according to an embodiment of the present invention;

FIG. 2 illustrates a schema for indexing information about software assets of business to create a software index;

FIGS. 3 to 5 are example software maps built using the software index; and

FIGS. 6 to 8 are example styled software maps that may be published to end-users.

### DESCRIPTION OF EMBODIMENTS

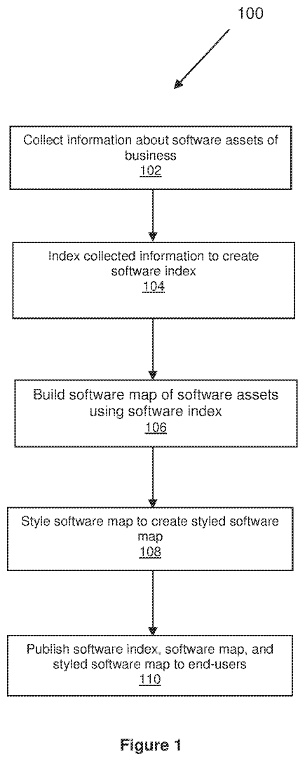

FIG. 1 illustrates a method 100 of indexing and mapping software assets of a business according to an embodiment of the present invention. The method 100 may be implemented by a computer system (not shown) specifically programmed with computer instructions to perform the steps of the method 100. The computer instructions may be implemented as downloadable or non-downloadable software, for example software as a service, executed in the computer system.

The method 100 may start at step 102 by collecting or surveying information about software assets of a business. Next at step 104, the collected information may be indexed to create a software index for the business. More specifically, software indexing may be considered as a collaborative process of surveying high-level software asset information and recording it in an active/verifiable software index. As such, the software index may comprise a master store for high-level software asset metadata that is: easy to access and search; broadly consumable; a launching pad (eg, web links) to reach more detailed information in other systems; and open for read/write by other systems (eg, APIs and Webhooks).

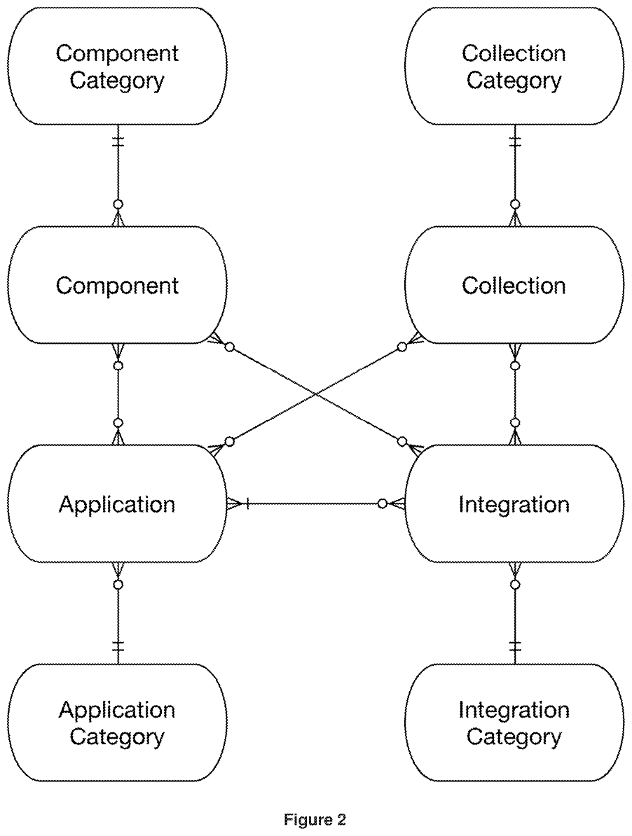

The collection of information about software assets of the business to create the software index may be performed using the indexing schema illustrated in FIG. 2. The software index may be an open platform that further comprises data imported and exported from file (eg, CSV, or via API). The software index may comprise a data set that comprises, for example, information or metadata about one or more of applications, application categories, integrations, integration categories, collections, collection categories, components, and component categories.

Referring to FIG. 2, “Applications” may, for example, comprise applications that are broadly known and hold data at rest. “Application categories” may be used to assign business ownership or tine of Business' to applications. “Integrations” may carry specific data between two applications and may not store data at rest. “Integration categories” may be used to describe different integration technologies. “Collections” may comprise a list of applications and/or integrations. “Collection categories” may be used to differentiate between business processes and project scope. “Components” may support applications and/or integrations. “Component categories” may be aligned to supporting platforms or development patterns. All asset items (eg, Applications, etc) may be linked to a single category. The software index may further comprise custom fields. Other equivalent or alternative metadata may also be used for the software index.

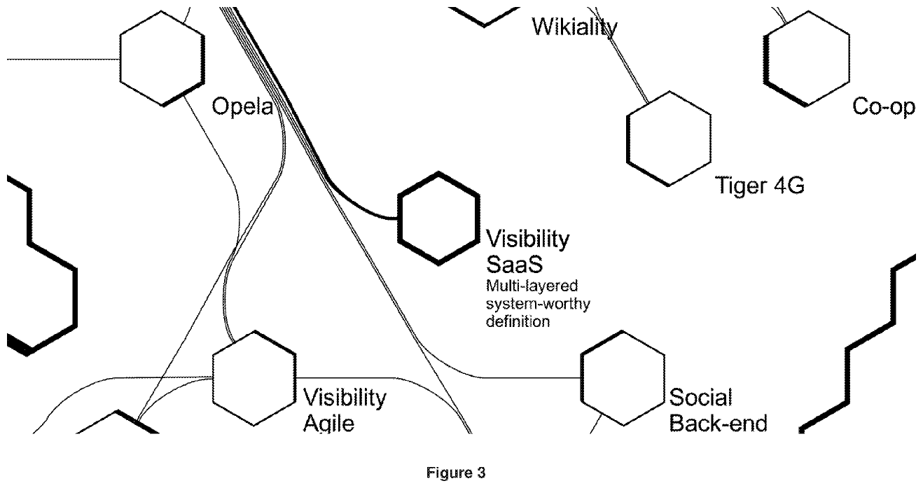

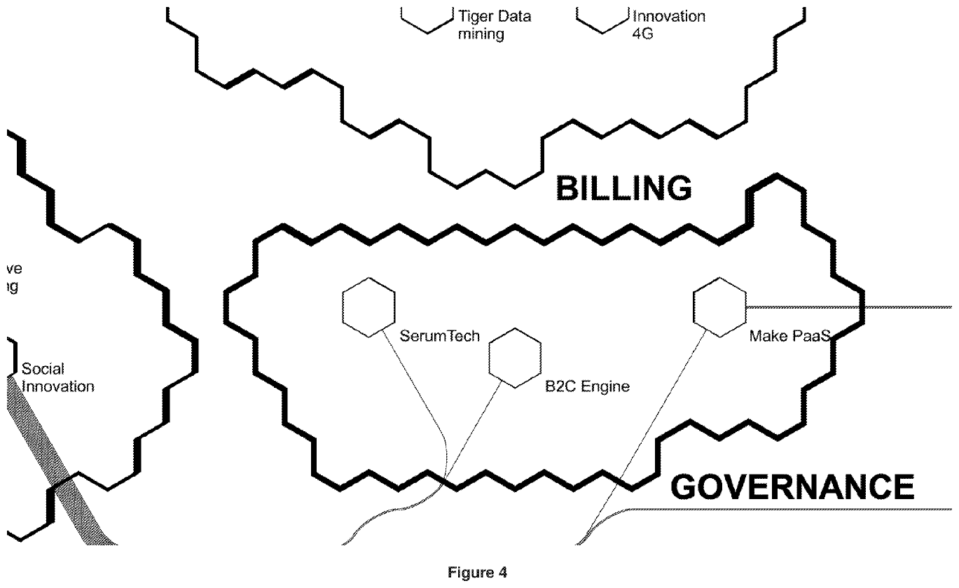

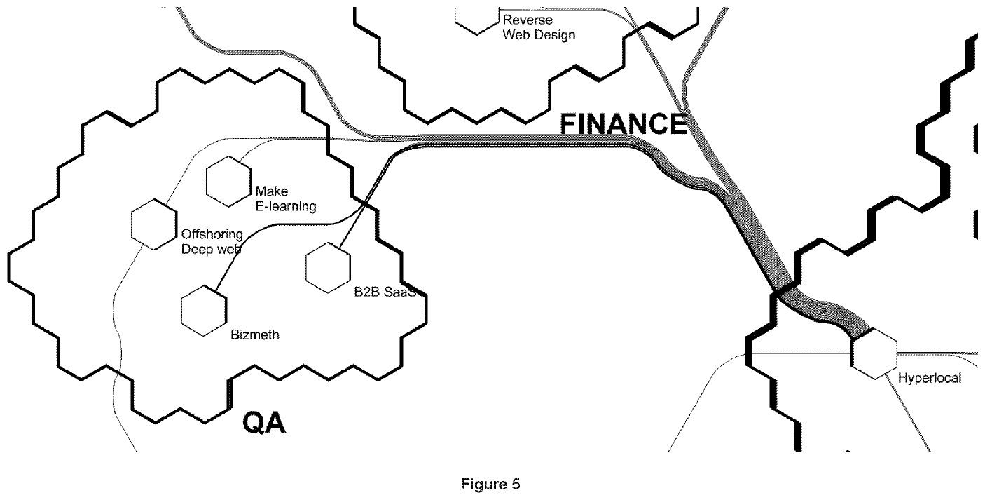

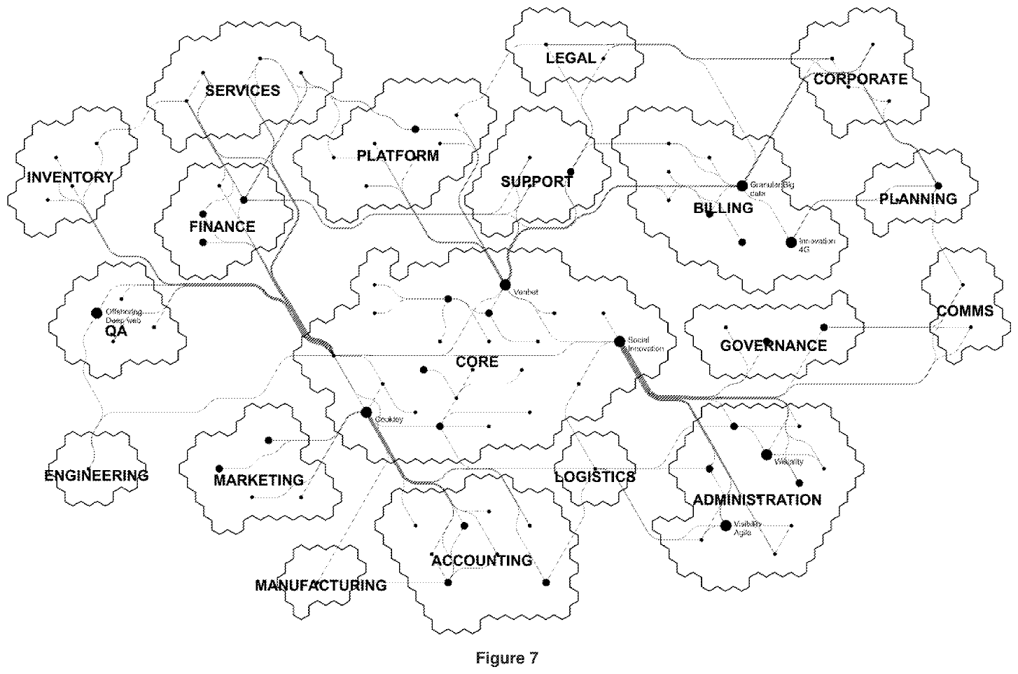

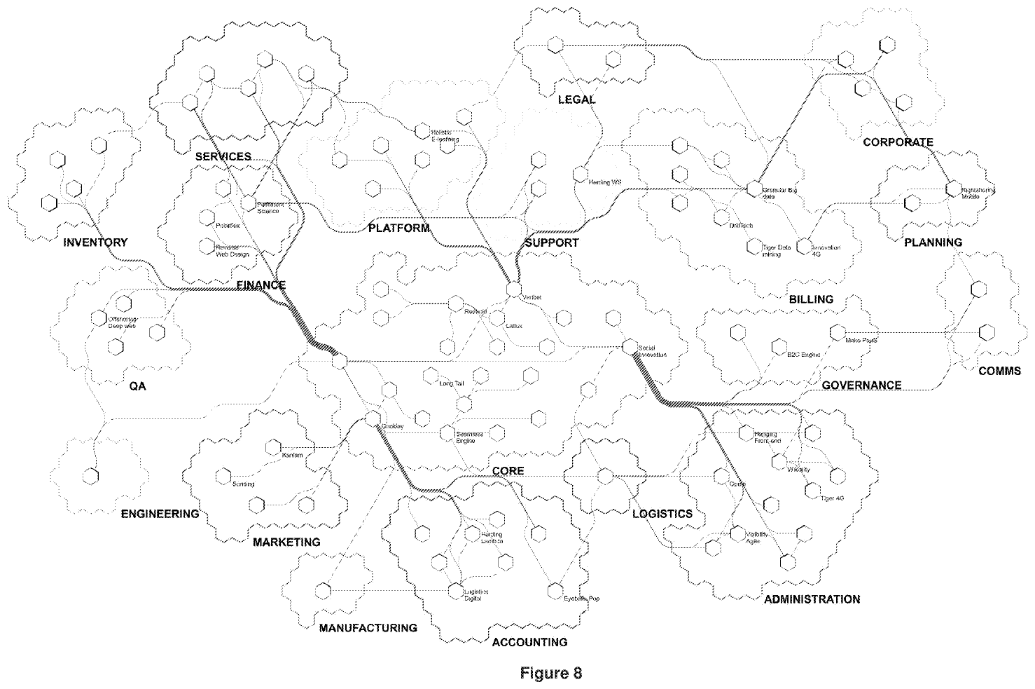

Next at step 106, the software index may be used to build a software map of the software assets. Example software maps built using the software index created at step 104 are illustrated in FIGS. 3 to 8. The software map may, for example, comprise a cartographic visualisation of the software index using geographic metaphors. The geographic metaphors may comprise cities/towns, continents/states/islands, and highways/roads in which: applications represent cities/towns (see FIG. 3); application categories represent continents/states/islands (see FIG. 4); and integrations represent highways/roads (see FIG. 5).

The software map may, for example, comprise a hexagonal-grid map in which applications are represented as individual hexagonal grid cells; application categories are represented as groups of hexagonal grid cells; and integrations are represented as interconnect lines between hexagonal grid cells. The interconnect lines may, for example, be routed between sides of hexagonal grid cells using a best routing algorithm.

The method 100 may then move to step 108 by styling the software map to create a styled software map. In other words, once a software map has been built, it is a series of attachments linking assets from the software index to coordinates on the software map. The styling of the software map may then be used to inform a custom rendering engine how to present or display the software map for viewing by an end-user. For example, WebGL may be used to render software maps to allow large software maps to be displayed. The software map may therefore be considered to be a visualisation of software assets via attachment to a static grid and rendering via dynamic map styles.

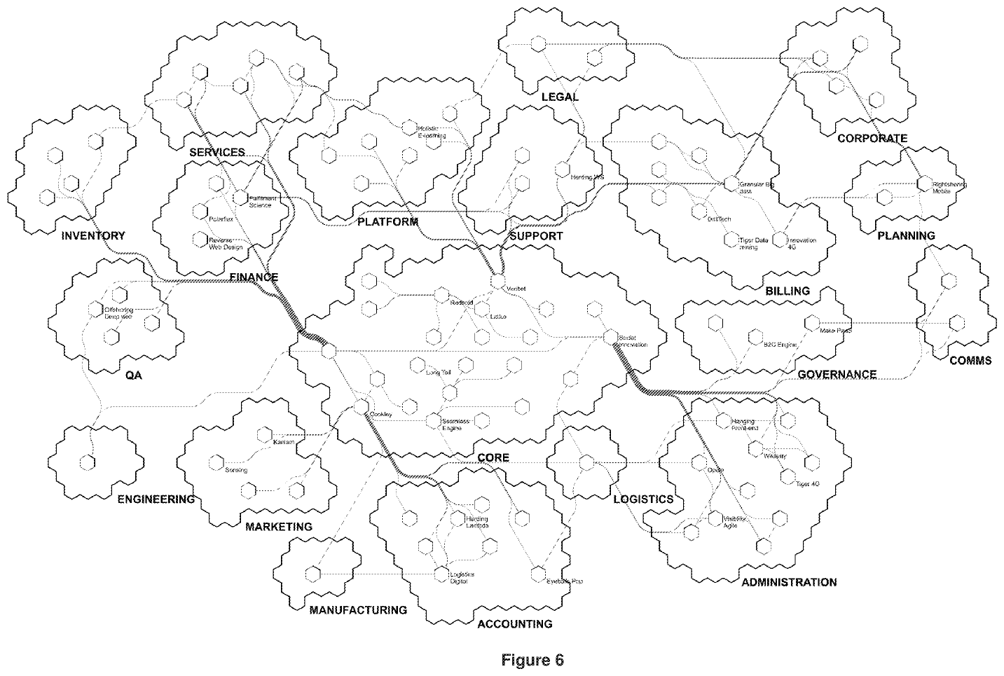

The styling of the software map may, for example, comprise one or more of layer, shape, colour, border, width, fill colour, and fill opacity. The styling of the software map may further comprise zoom-based styling or data-based styling, as illustrated in FIGS. 6 to 8, for navigating and browsing the software map.

The method 100 may end at step 110 by publishing (or sharing) one or more of the software index, software map, and styled software map to an end-user. The one or more of the software index, software map, and styled software map may, for example, be published to the end-user via one or more addons. Publication may be performed using a publication engine for sharing links of software indices, software maps, and styled software maps to different end-users, such as consumers of software asset information, for example, employees of the business. Publishing may be achieved through “addons” that specify how one or more of the software index, software map, or styled software map are displayed and interacted with by end-users. Addons may be provided with preconfigured functionality, styles and visualisations. For example, addons may include Metamap for visual interrogation from a software map, Dashmap as a real-time dashboard, and Metasearch that provides textual interrogation of a software index. Other alternative or equivalent addons may also be provided for preconfigured publication of software indices, software maps, and styled software maps to end-users. Once published, the software indices, software maps, and styled software maps may be displayed to (or viewed by), and interacted with, by the end-users.

Advantageously, the software index, software map, styled software map, and publications thereof are change tolerant to one another. For example, the system may be designed in such a way that the majority of changes in the previous step will not significantly impact the quality of the next step. In other words, by default, the visualisations provided by the software maps are highly tolerant of changes in their underlying data.

In addition, the software map may be partially or wholly built and maintained either manually or automatically. For example, although some parts of the software map may be drawn automatically (eg, integration channels, regions, etc), when software maps get very large there may be a need to provide further automation, such as using machine learning algorithms to both automatically create software maps from scratch, and/or to maintain an existing map (whether created manually or automatically initially).

Embodiments of the present invention provide a computer-implemented method of indexing and visualising software assets of businesses that is both generally and specifically useful for visualising highly integrated software systems as a tool to assist in identifying, understanding and communicating information about business software.

The software indexing solution provided by embodiments of the invention addresses the data quality problem of conventional business software architecture tools, while the software mapping solution of embodiments addresses the abstraction level problem of conventional tools. The software indexing of embodiments of the invention may be considered to be the ‘Google Search’ of software, and the software mapping may be considered to be the ‘Google Maps’ of software.

For the purpose of this specification, the word “comprising” means “including but not limited to,” and the word “comprises” has a corresponding meaning.

The above embodiments have been described by way of example only and modifications are possible within the scope of the claims that follow.

1. A computer-implemented method, comprising:
collecting information about software assets of a business;
indexing the collected information to create a software index;
building a software map of the software assets using the software index;
styling the software map to create a styled software map; and
publishing one or more of the software index, software map, and styled software map to an end-user.

2. The method of claim 1, wherein the software index, software map, styled software map, and publications thereof are loosely coupled to one another.

3. The method of claim 1, wherein the software map is partially or wholly built and maintained either manually or automatically.

4. The method of claim 1, wherein the software index comprises information about one or more of applications, application categories, integrations, integration categories, collections, collection categories, components, and component categories.

5. The method of claim 1, wherein the software map comprises a cartographic visualisation of the software index using geographic metaphors.

6. The method of claim 5, wherein the geographic metaphors comprise cities/towns, continents/states/islands and highways/roads, wherein:
applications represent cities/towns;
application categories represent continents/states/islands; and
integrations represent highways/roads.

7. The method of claim 4, wherein the software map comprises a hexagonal-grid map, and wherein:
applications are represented as individual hexagonal grid cells;
application categories are represented as groups of hexagonal grid cells; and
integrations are represented as interconnect lines between hexagonal grid cells.

8. The method of claim 1, wherein the styling of visual attributes of the software map comprises styling one or more of layer, shape, colour, border, width, fill colour, and fill opacity.

9. The method of claim 1, wherein the styling of visual attributes of the software map further comprises zoom-based styling or data-based styling.

10. The method of claim 1, wherein the styled software map is displayed to the end-user using a custom rendering engine.

11. A system comprising one or more computers and one or more storage devices storing instructions that are operable, when executed by the one or more computers, to cause the one or more computers to perform operations comprising:
collecting information about software assets of a business;
indexing the collected information to create a software index;
building a software map of the software assets using the software index;
styling the software map to create a styled software map; and
publishing one or more of the software index, software map, and styled software map to an end-user.

12. A visualisation of software assets of a business, the visualisation comprising a software map produced by the method of claim 1 or the system of claim 11.
